(19) United States
(12) Patent Application Publication
(10) Pub. No.: US 2024/0319877 A1
(43) Pub. Date: Sep. 26, 2024

(54) REDUCTION OF INPUT AND OUTPUT LATENCIES IN RESPONSE TO STORAGE FAILURE AT A SITE

(71) Applicant: INTERNATIONAL BUSINESS MACHINES CORPORATION, Armonk, NY (US)

(72) Inventors: Abhishek JAISWAL, Pune (IN); Subhojit ROY, Pune (IN); Bharti SONI, Pune (IN); Komal Shailendra SHAH, Pune (IN); Shrirang Shrikant BHAGWAT, Pune (IN)

(21) Appl. No.: 18/188,840

(22) Filed: Mar. 23, 2023

(51) Int. Cl. G06F 3/06

(52) U.S. Cl. CPC G06F 3/061; G06F 3/0655; G06F 3/0679

(57) ABSTRACT

A first volume is maintained at a primary site and a second volume is maintained at a secondary site, where operations to mirror the first volume at the primary site to the second volume at the secondary site are performed while other volumes of the primary site and the secondary site are maintained in a remote copy relationship. Input/Output (I/O) operations comprising writing a metadata on the first volume at the primary site are performed and corresponding read I/O operations are performed on the second volume at the secondary site. In response to determining that the metadata read in two consecutive read I/O operations on the second volume at the secondary site does not reflect updates as requested to be made to the first volume at the primary site, determining that the primary site has failed.

### BACKGROUND

Embodiments relate to a method, system, and computer program product for the reduction of input and output latencies in response to storage failure at a site.

A storage controller may control access to storage for one or more host computational devices that may be coupled to the storage controller over a network. A storage management application that executes in the storage controller may manage a plurality of storage devices, such as disk drives, tape drives, flash drives, direct access storage devices (DASD), etc., that are coupled to the storage system. A host may send Input/Output (I/O) commands to the storage controller and the storage controller may execute the I/O commands to read data from the storage devices or write data to the storage devices.

Remote copy is a protocol to replicate a storage volume from a first storage controller at a first site to a second storage controller in a second site. The first storage controller may be referred to as a primary storage controller and the second storage controller may be referred to as a secondary storage controller. The first site may be referred to as a local site and the second site may be referred to as a remote site. The first site and the second site may be located proximate to each to other in the same room or in same building, or may be separated from each other by a significant distance and may be in different buildings, different areas of the same city, or in different cities.

### SUMMARY OF THE PREFERRED EMBODIMENT

Provided are a method, system, and computer program product in which a first volume is maintained at a primary site and a second volume is maintained at a secondary site, where operations to mirror the first volume at the primary site to the second volume at the secondary site are performed while other volumes of the primary site and the secondary site are maintained in a remote copy relationship. Input/Output (I/O) operations comprising writing a metadata on the first volume at the primary site are performed and corresponding read I/O operations are performed on the second volume at the secondary site. In response to determining that the metadata read in two consecutive read I/O operations on the second volume at the secondary site does not reflect the updates, as requested to be made to the first volume at the primary site, a determination is made that the primary site has failed.

In additional embodiments, in response to determining that the metadata read in two consecutive read I/O operations on the second volume at the secondary site reflects updates made in the first volume at the primary site, a determination is made that the primary site is functioning properly.

In further embodiments, in response to determining that the primary site has failed, a switching over is performed to an I/O application instance at the secondary site.

In certain embodiments, heartbeat mechanisms are used for the first volume and the second volume to determine whether the primary site and the secondary site are operational.

In further embodiments, the first volume and the second volume are created on a plurality of criteria to meet host cluster requirements on a per site, per host, per I/O application, per remote copy relationship, or per storage pool, based on needs.

In additional embodiments, storage failure detection is performed at the primary site in a cluster using heartbeat mechanisms in association with special mirrored volumes comprising the first volume and the second volume.

In yet additional embodiments, an automated application failover onto a host which is located geographically in a same site as a surviving site is performed.

### BRIEF DESCRIPTION OF THE DRAWINGS

Referring now to the drawings in which like reference numbers represent corresponding parts throughout:

FIG. 1 illustrates a block diagram of a computing environment for latency improvement in a storage system, in accordance with certain embodiments.

FIG. 2 illustrates a block diagram that shows characteristics of special mirrored volumes, in accordance with certain embodiments.

FIG. 3 illustrates a block diagram that shows first operations on special mirrored volumes, in accordance with certain embodiments.

FIG. 4 illustrates a block diagram that shows second operations on special mirrored volumes, in accordance with certain additional embodiments.

FIG. 5 illustrates a flowchart that shows operations for improving latency via special mirrored volumes, in accordance with certain additional embodiments.

FIG. 6 illustrates a flowchart that shows additional operations for improving latency via special mirrored volumes, in accordance with certain additional embodiments.

FIG. 7 illustrates a computing environment in which certain components of FIG. 1 may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

High availability is becoming an important feature in computing environments due to advances in computing infrastructure components such as networking and storage. Storage systems may provide continuous availability of data during planned and unplanned outages. For example, certain storage systems may provide dual-site access to a volume. Many such storage system volumes may have a copy at one site and second copy at another site. Data that is written to a volume is automatically updated on both copies. If a storage controller at one site is no longer available, the storage controller at the other site can provide access to the volume without the need for any manual intervention. The application can fail over to the alternate site and start accessing the volume from the alternate site.

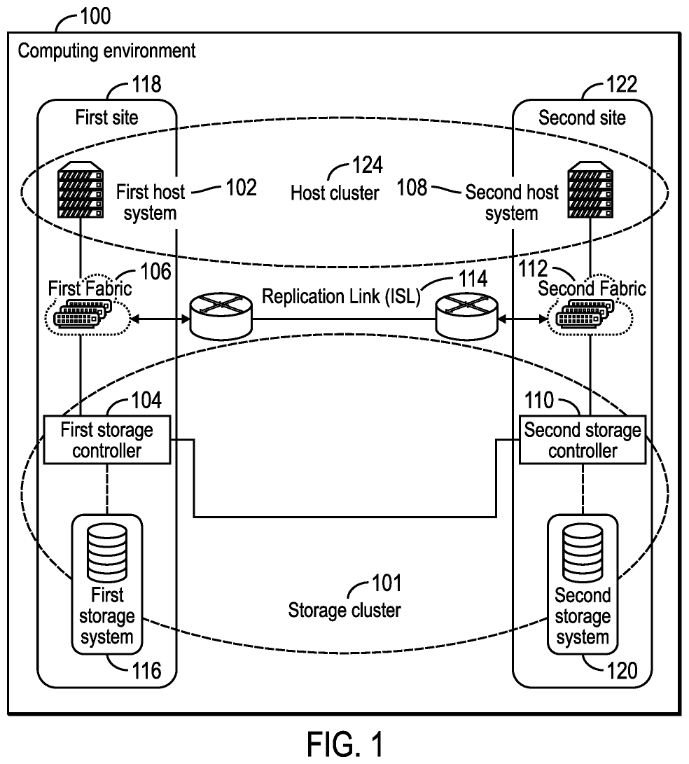

FIG. 1 illustrates a block diagram 100 of a computing environment of a cluster configuration that includes a storage cluster 101 comprising storage controllers and storage devices where the storage cluster 101 is coupled to host systems, in accordance with certain embodiments. In certain embodiments, the storage controllers, host systems, and other computational devices shown in FIG. 1 may comprise any suitable computational device including those presently known in the art, such as, a personal computer, a workstation, a server, a mainframe, a hand held computer, a palm top computer, a head mounted computer, a telephony device, a network appliance, a blade computer, a processing device, a controller, etc. The elements shown in FIG. 1 may in any suitable network, such as, a storage area network, a wide area network, the Internet, an intranet, etc., or in a cloud computing environment.

In FIG. 1, hosts are coupled with storage controllers at a site via local network fabric (e.g., a first host system 102 is coupled with a first storage controller 104 via a first fabric 106, and a second host system 108 is coupled with a second storage controller 110 via a second fabric 112). Hosts are also coupled with inter-site storage controllers via inter-switch link 114 and remote network fabrics (e.g., the first host system 102 is coupled with the second storage controller 110 via the first fabric 106, the ISL 114, and the second fabric 112). Each storage controller is capable of performing read or write through the local fabric as requested by hosts under normal circumstances (e.g., the first storage controller 104 is capable of READ/WRITE on the first storage system 116 which is present locally the first site 118, and the second storage controller 110 is capable of READ/WRITE on the second storage system 120, which is present locally in the second site 122). The first site 118 and the second site 122 may be located proximate to each to other in the same room or in same building, or may be separated from each other by a significant distance and may be in different buildings, different areas of the same city, or in different cities.

In a high availability environment, mechanisms for performing data READ/WRITE requests data from volumes available on the local site to reduce trip delays resulting from fetching data from the remote site. In case of failure of a storage controller or storage system on primary site (e.g., the first site 118), co-located hosts 102 may need to access storage systems containing copy of data, in secondary site (e.g., the second site 122) over the ISL 114 where the ISL 114 is also referred to a replication link 114.

In certain embodiments, if the first host system 102 in the first site 118 is running production applications, then all I/O requests by an application will be served to the first host system 102 from the first storage controller 104 which is on the local site.

Every WRITE request is first transferred to the first storage controller 104 and also internally transferred to the second storage controller 110 over ISL 114 (replication link) for the purpose of maintaining an up to date second copy of data at the second storage system 120. Once the first storage controller 104 receives acknowledgement of completion of WRITE request from the second storage controller 110, the host 102 is notified of WRITE completion. Therefore, WRITEs are synchronously replicated between the storage controllers.

Every READ request is served by the first storage controller 104 as data is consistent on both the first storage system 116 and the second storage system 120 located respectively at the first site 118 and the second site 122. Hence for READ requests, there is no need for involvement of the ISL 114 (replication link).

On the host side, host failure can turn out to be a single point of failure as applications may not have a way to access the volumes in case of host failure. To solve this problem, host clustering is implemented in various environments and an exemplary host cluster 124 is shown. Host clustering is a feature that allows failover of I/O applications on one host to another host in case of host or application failure, where the two hosts may be geographically separated.

In case of a storage failure, one of the storage systems is unavailable. Hence, all I/O requests are served by the storage controller located at surviving site. If a host in one site needs to access storage systems in another site, all READ/WRITE requests need to be transferred over ISL 114 and this causes extra delays especially for READ I/O commands. Not only is an extra hop over the ISL 114 required, but there is also the possibility of congestion on the ISL 114 in case it is shared with other types of data traffic like host-to-host traffic.

For example, in one instance the first site 118 has seen a failure of the first storage controller 104 or the first storage system 116. In this case, the first host system 102 would choose remaining active paths connecting to the second storage system 120 located in the second site 122 (across ISL 114) and perform I/O operations. Every READ/WRITE request would now travel over ISL 114 and will be served by the second storage controller 110. In case of READ request, which was earlier served by the locally present first storage controller 104, the READ request has now to be transmitted over the ISL 114 to be served by the remotely located second storage controller 110 at the second site 122. This communication over ISL 114 adds extra latency in READ I/Os. Time bound applications may start facing performance issues due to READ I/Os taking longer than usual and also consume more network resources. And since the first site 118 houses the first host 102 which may be running a production application, the extra latency may be apparent to users who interact with the production application.

Certain embodiments use special mirrored storage volumes to provide a solution to the above problem by detecting a storage failure at a site by a host cluster and triggering failover of host I/O application on to the surviving site even though the primary site host is still active and unaware of a storage failure on the primary site. Such failover of host I/O application may eliminate the extra latency in READ I/Os as well as eliminate or reduce potential performance issues as mentioned above, along with saving resources.

Additionally, certain previous solutions recommend the customer to perform application failover in storage failure scenarios at the primary site. But every time failure occurs, an administrator is required to take actions manually. Manual actions introduce additional delays in fixing the problem and extending the recovery time objective for the application. Certain embodiments propose a mechanism that does not require manual intervention and such embodiments introduce an automatic method to detect and remediate the issues in a failure scenario. The embodiments may eliminate the human error involved in existing manual actions and may improve the functioning of a computational devices included in a computing environment. It should be noted that the embodiments are applicable to improve other previously adopted mechanisms for remote copy and failover besides the ones described here.

In certain embodiments there are special volumes configured at the primary site that are synchronously mirrored over to the secondary site. The host cluster from the primary site mays perform a write I/O on this special volume at regular intervals (this is referred to as disk-based heartbeat). Such writes will update special volumes with host specific metadata which will be incremental after each successful write, i.e., timestamps, counters or any such metadata which has unique identity are written in an incremental manner. For example, the special volume on the primary site may have timestamps written as metadata at periodic intervals of time and these timestamps are synchronously copied over to the special volume at the secondary site.

Certain embodiments perform detection of storage failure at primary site by running heartbeat mechanism instrumented by host cluster with the use of the special mirrored volumes. Upon detecting storage failure, the host cluster invokes failover of host I/O application onto a surviving storage site. Storage failure is detected with the use of heartbeat and is performed by a host cluster entity that uses the special mirrored volumes to reduce I/O latency relative to mechanisms that do not use the special volumes.

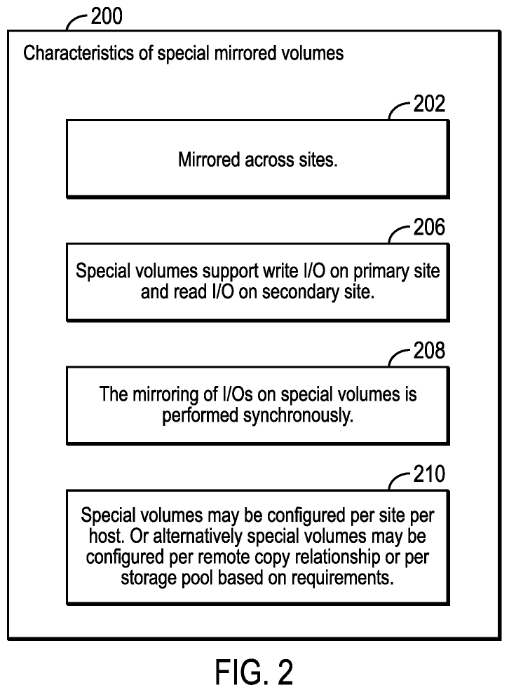

FIG. 2 shows a block diagram 200 that shows characteristics of special mirrored volumes. These volumes are mirrored across sites (as shown via reference numeral 202). For example, a first special volume may be maintained in the first site 118 (i.e., primary site) and a second special volume may be maintained in the second site 122 (i.e., secondary site).

Special volumes support writes I/O on primary site, and read I/O operations are performed on the secondary site to determine whether metadata written on the special volume in the primary site has been correctly copied to the secondary site (as shown via reference numeral 206). For example, the first special volume maintained in the first site 118 that is a production site may support writes, and metadata written to the first special volume in the first site 118 may be copied to the second special volume in the second site 122 and then read.

The mirroring of I/O on the special volumes are performed synchronously (as shown via reference numerals 208) between the first special volume at the first site and the second special volume at the second site.

These special volumes can be configured per site per host. Or alternatively special volumes may be configured per remote copy (RC) relationship or per storage pool based on need (as shown via reference numeral 210).

Each read/write operation can have application specific timeout that may depend on host operating system, I/O application, system stack etc. Also, the host cluster may have capability to define retry timeout for such read/write I/Os.

As the special volume is mirrored on the secondary site, it can only be read from that site. The host cluster will regularly at periodic intervals of time read from the mirrored special volume from the secondary site. As long as the host cluster finds an increment in metadata at secondary site via successful reads, it can deduce that primary site is up and running without any storage failure. When the data is read successfully and it is same as that found in previous read, it means the storage at primary site has failed and unable to serve I/O operations.

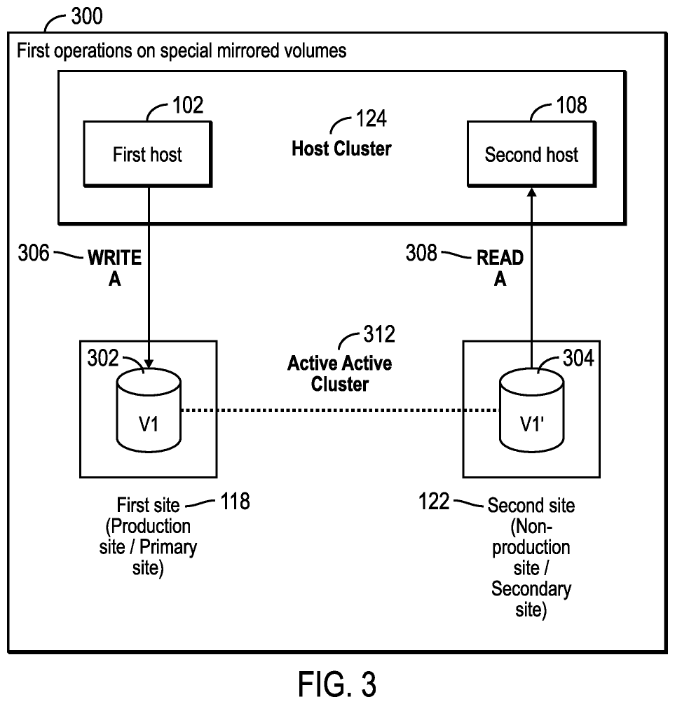

FIG. 3 illustrates a block diagram 300 that shows first operations on special mirrored volumes, in accordance with certain embodiments.

In FIG. 3, the production site 118 (first site or primary site) keeps writing some data on the special mirrored volume V1 302 in the production site 118 at certain periodic intervals. This data is read by non-production site 122 (second site or secondary site) by issuing a READ command on special mirrored volume V1′ 304 on the non-production site 122. A host cluster 124 which manages hosts in both the sites, compares this data as it is aware of what is written by the first host 102 and what is read by the second host 108. For example, if the first host 102 writes data A 306 to special volume V1 302, a subsequent read 308 from special volume V1′ 304 should read A only. If data read from special volume V1′ 304 does not match with A, then there is failure in one of the sites.

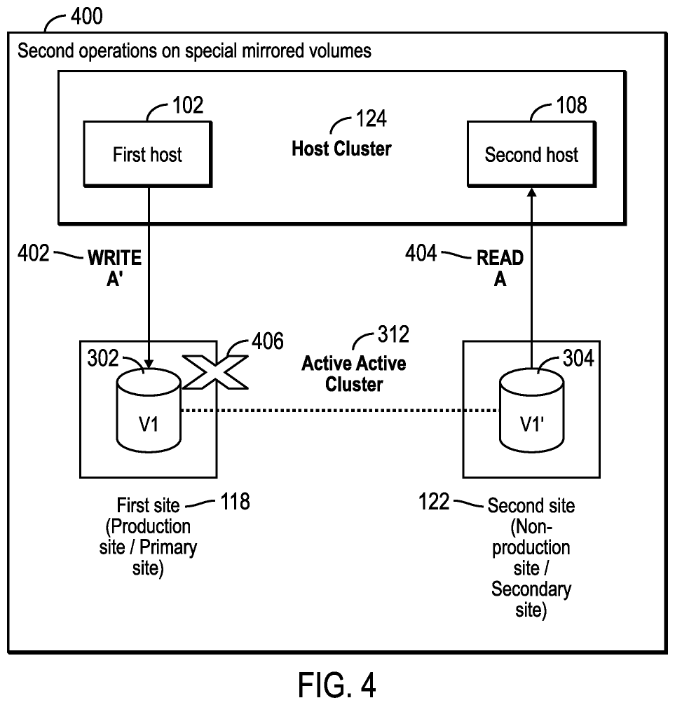

FIG. 4 illustrates a block diagram 400 that shows second operations on special volumes, in accordance with certain additional embodiments. FIG. 4

After writing the data A on special volume V1 302 (shown in earlier in FIG. 3), in the next instance data A′ 402 (i.e., A+delta which is a change on the previous data such as a new timestamp) is attempted to be written by the first host 102 in the first site 118.

Now, if due to storage failure, A′ is not written to the special volume V1 302, a read command on the special volume V1′ 304 will return value as A (as shown via reference numeral 404) as A was the value that was written previously (as shown earlier in FIG. 3). As no new write occurred on special volume V1 302, the special volume V1′ 304 is also at the older copy. Since in the next instance, A′ was expected to be read from special volume V1′ 304, the old copy of data A as read by the second host 108 indicates the failure of storage at the first site 118. As the host cluster 124 detects this storage failure at the production site 118, it stops the host I/O application instance running in the production site 118 and fails over the I/O application instance at surviving secondary site 122.

At this point, the host cluster application will select the nearest host to the surviving secondary site 122 and switch the I/O application instance to use the secondary site 122 instead of continuing with the application running on the primary site 118 with higher latencies due to I/O operations being served from the secondary storage.

In certain embodiments, timestamps are used at each interval for metadata. The timestamps are always incremental and unique at any given instance of time. Continuous reads of same timestamp over time indicate that targeted volumes are not in synchrony for given instance.

Thus, when successive metadata reads is same as that found in previous read (e.g., the timestamps did not change in successive reads on the special volume 304), it means the storage at primary site has failed and unable to serve I/O operations. This is depicted in FIG. 4 that shows that the primary site has failed (reference numeral 406 as indicated with a X mark).

In another instance data A 306 is written by the first host 102 in the first site 118. The same data A is read by the second host 108 in the second site 122. Now, in the next instance data A′ (i.e., A+delta which is a change on the previous data such as a new timestamp) is written by the first host 102 in the first site 118. The data written on the special volume may be referred to as metadata.

If there is no storage failure at the primary site, A′ is written to the special volume V1 302, and a read command on the special volume V1′ 304 will return value as A′. The system can then conclude that the primary site is operational. The mirroring of the special volumes is shown within a cluster referred to as an active-active cluster 312.

Therefore, as long as host cluster finds increments in metadata at the secondary site via successful reads, it can deduce that primary site is up and running without any storage failure.

As a result, certain embodiments provide at least following improvements to computational devices over current implementations: (A) Reduction in I/O latencies for the duration during which the storage at primary site is down; (B) No administrative intervention to switch over the application from the primary to the secondary site; (C) Network protocol agnostic scheme is provided; (D) Does not require any other specialized equipment and it is relatively easy to implement and integrate; (E) Reduces network resource utilization and possible congestion scenarios if the ISL is shared between storage clustering traffic and application clustering traffic.

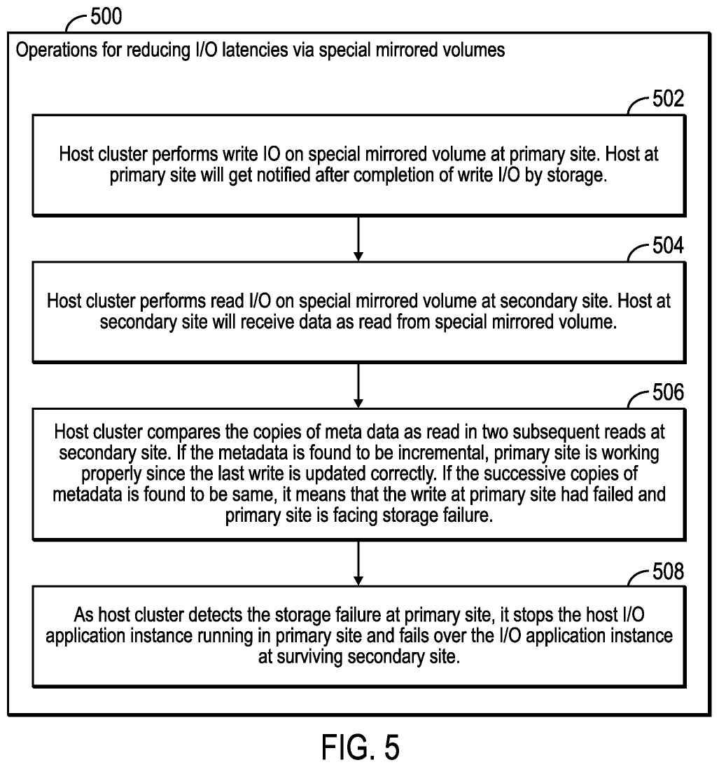

FIG. 5 shows exemplary operations being performed in certain embodiments.

Control starts at block 502 in which the host cluster performs write I/O on special mirrored volume at primary site. Host at primary site will get notified after completion of write I/O by storage.

From block 502 control proceeds to block 504 in which the host cluster performs read I/O on special mirrored volume at the secondary site. Host at secondary site will then receive data as read from special mirrored volume.

Control proceeds to block 506 in which the host cluster compares the copies of metadata as read in two subsequent reads at secondary site. If the metadata is found to be incremental, primary site is working properly since the last write is updated correctly. If the copies of metadata are found to be identical in successive reads, it means that the write at primary site had failed and primary site is facing storage failure.

As host cluster detects the storage failure at primary site, it stops the host I/O application instance running in the primary site and fails over the I/O application instance at surviving secondary site (at block 508).

In certain storage configurations, even if a site goes down, the host can perform the I/O operations from a second copy of the volume located at other (surviving) site. Also host cluster environment, does keep a record of hosts and targets for both sites.

Using such record, the host cluster can easily trigger a failover of I/O application to a host which is geographically located nearer to surviving secondary site.

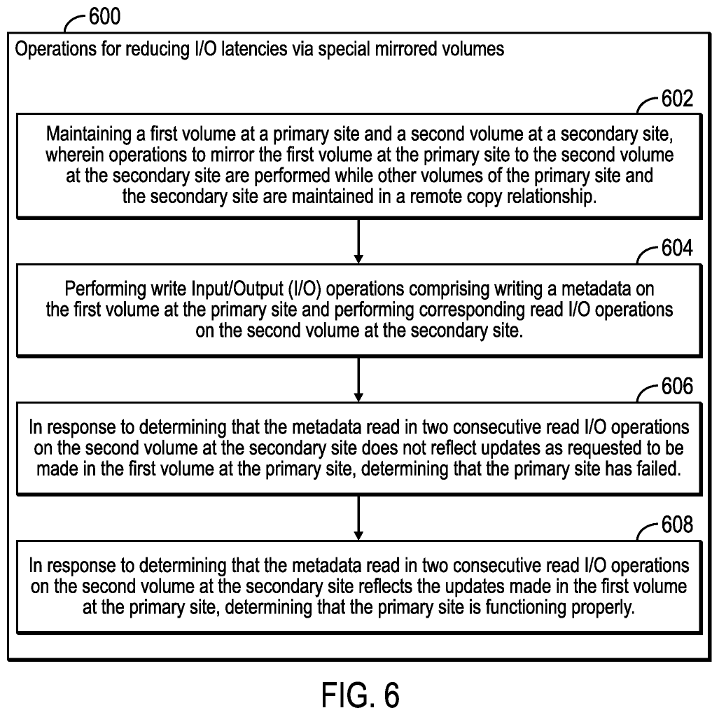

FIG. 6 illustrates a flowchart 600 that shows additional operations for improving latency via special mirrored volumes, in accordance with certain additional embodiments.

Control starts at block 602 in which a first volume is maintained at a primary site and a second volume is maintained at a secondary site, where operations to mirror the first volume at the primary site to the second volume at the secondary site are performed while other volumes of the primary site and the secondary site are maintained in a remote copy relationship.

From block 602 control proceeds to block 604 in which I/O operations comprising writing a metadata on the first volume at the primary site are performed and corresponding read I/O operations on the second volume at the secondary site are performed. In response to determining (at block 606) that the metadata read in two consecutive read I/O operations on the second volume at the secondary site does not reflect updates as requested to be made in the first volume at the primary site, a determination is made that the primary site has failed.

From block 606 control proceeds to block 608 in which in response to determining that the metadata read in two consecutive read I/O operations at the secondary site reflects the updates made in the first volume at the primary site, a determination is made that the primary site has failed, and host I/O application switchover may be performed upon this determination automatically.

In certain embodiments, in response to determining that the primary site has failed, a switching over is performed to an I/O application instance at the secondary site.

Therefore, FIGS. 1-6 illustrate certain embodiments to improve I/O latency in a storage environment by employing special mirrored volumes. In certain embodiments, heartbeat mechanisms are used for the first volume and the second volume to determine whether the primary site and the secondary site are operational. The heartbeat mechanisms may be implemented in certain embodiments via timestamps that are written incrementally. In further embodiments, the first volume and the second volume are created on a plurality of criteria to meet host cluster requirements on a per site, per host, per I/O application, per remote copy relationship basis, or per storage pool based on needs. In additional embodiments, storage failure detection is performed at primary site in a cluster using heartbeat mechanisms in association with special mirrored volumes comprising the first volume and the second volume. In yet additional embodiments, an automated application failover onto a host which is located geographically in a same site as a surviving site is performed and I/O latencies are reduced over mechanisms that avoid employing the special mirrored volumes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

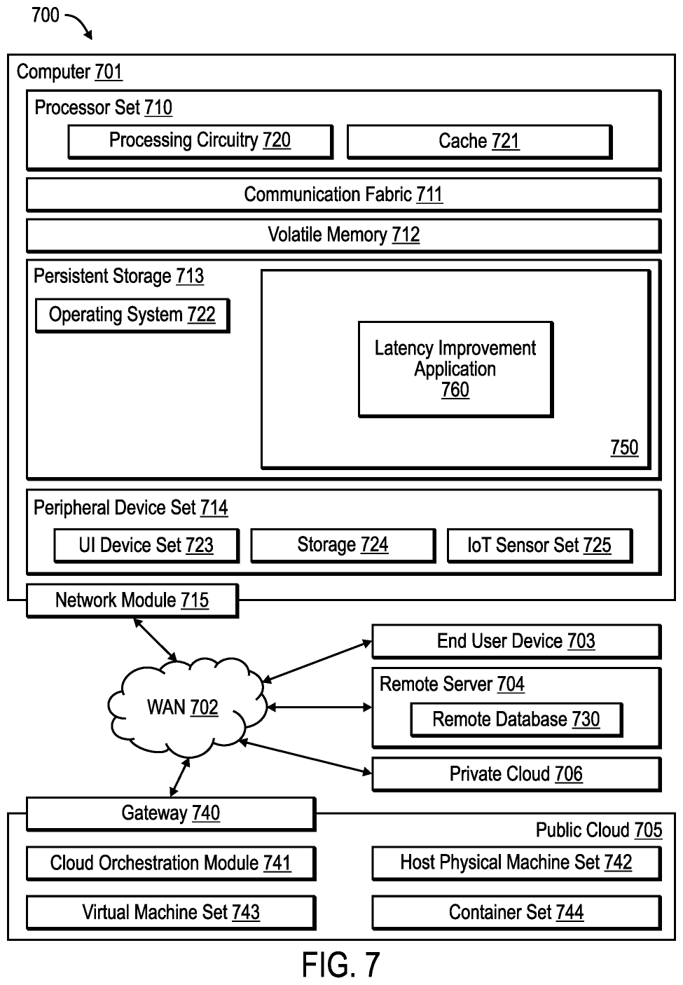

In FIG. 7, computing environment 700 contains an example of an environment for the execution of at least some of the computer code (block 750) involved in performing the operations of a latency improvement application 760.

In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. I/O T sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method comprising:
maintaining a first volume at a primary site and a second volume at a secondary site, wherein operations to mirror the first volume at the primary site to the second volume at the secondary site are performed while other volumes of the primary site and the secondary site are maintained in a remote copy relationship;
performing write Input/Output (I/O) operations comprising writing a metadata on the first volume at the primary site and performing corresponding read I/O operations on the second volume at the secondary site; and
in response to determining that the metadata read in two consecutive read I/O operations on the second volume at the secondary site does not reflect updates as requested to be made to the first volume at the primary site, determining that the primary site has failed.

2. The method of claim 1, the method further comprising:
in response to determining that the metadata read in two consecutive read I/O operations on the second volume at the secondary site reflects the updates made in the first volume at the primary site, determining that the primary site is functioning properly.

3. The method of claim 1, wherein in response to determining that the primary site has failed, switching over to an I/O application instance at the secondary site.

4. The method of claim 1, wherein heartbeat mechanisms are used for the first volume and the second volume to determine whether the primary site and the secondary site are operational.

5. The method of claim 1, wherein the first volume and the second volume are created on a plurality of criteria to meet host cluster requirements on a per site, per host, per I/O application, per remote copy relationship, or per storage pool, based on needs.

6. The method of claim 1, wherein storage failure detection is performed at primary site in a cluster using heartbeat mechanisms in association with special mirrored volumes comprising the first volume and the second volume.

7. The method of claim 6, wherein an automated application failover onto a host which is located geographically in a same site as a surviving site is performed and I/O latencies are reduced over mechanisms that avoid employing the special mirrored volumes.

8. A system, comprising:
a memory; and
a processor coupled to the memory, wherein the processor performs operations, the operations comprising:
maintaining a first volume at a primary site and a second volume at a secondary site, wherein operations to mirror the first volume at the primary site to the second volume at the secondary site are performed while other volumes of the primary site and the secondary site are maintained in a remote copy relationship;
performing write Input/Output (I/O) operations comprising writing a metadata on the first volume at the primary site and performing corresponding read I/O operations on the second volume at the secondary site; and
in response to determining that the metadata read in two consecutive read I/O operations on the second volume at the secondary site does not reflect updates as requested to be made to the first volume at the primary site, determining that the primary site has failed.

9. The system of claim 8, the operations further comprising:
in response to determining that the metadata read in two consecutive read I/O operations on the second volume at the secondary site reflects the updates made in the first volume at the primary site, determining that the primary site is functioning properly.

10. The system of claim 8, wherein in response to determining that the primary site has failed, switching over to an I/O application instance at the secondary site.

11. The system of claim 8, wherein heartbeat mechanisms are used for the first volume and the second volume to determine whether the primary site and the secondary site are operational.

12. The system of claim 8, wherein the first volume and the second volume are created on a plurality of criteria to meet host cluster requirements on a per site, per host, per I/O application, per remote copy relationship, or per storage pool, based on needs.

13. The system of claim 8, wherein storage failure detection is performed at primary site in a cluster using heartbeat mechanisms in association with special mirrored volumes comprising the first volume and the second volume.

14. The system of claim 13, wherein an automated application failover onto a host which is located geographically in a same site as a surviving site is performed and I/O latencies are reduced over mechanisms that avoid employing the special mirrored volumes.

15. A computer program product, the computer program product comprising a computer readable storage medium having computer readable program code embodied therewith, the computer readable program code when executed is configured to perform operations, the operations comprising:
maintaining a first volume at a primary site and a second volume at a secondary site, wherein operations to mirror the first volume at the primary site to the second volume at the secondary site are performed while other volumes of the primary site and the secondary site are maintained in a remote copy relationship;
performing write Input/Output (I/O) operations comprising writing a metadata on the first volume at the primary site and performing corresponding read I/O operations on the second volume at the secondary site; and
in response to determining that the metadata read in two consecutive read I/O operations on the second volume at the secondary site does not reflect updates as requested to be made in the first volume at the primary site, determining that the primary site has failed.

16. The computer program product of claim 15, the operations further comprising:
in response to determining that the metadata read in two consecutive read I/O operations on the second volume at the secondary site reflects the updates made in the first volume at the primary site, determining that the primary site is functioning properly.

17. The computer program product of claim 15, wherein in response to determining that the primary site has failed, switching over to an I/O application instance at the secondary site.

18. The computer program product of claim 15, wherein heartbeat mechanisms are used for the first volume and the second volume to determine whether the primary site and the secondary site are operational.

19. The computer program product of claim 15, wherein the first volume and the second volume are created on a plurality of criteria to meet host cluster requirements on a per site, per host, per I/O application, per remote copy relationship, or per storage pool, based on needs.

20. The computer program product of claim 15, wherein storage failure detection is performed at primary site in a cluster using heartbeat mechanisms in association with special mirrored volumes comprising the first volume and the second volume.
